(19) United States
(12) Patent Application Publication
(10) Pub. No.: US 2010/0037715 A1
(43) Pub. Date: Feb. 18, 2010

(54) DRIVE FOR A MOVABLE FURNITURE PART

(76) Inventor: Ingo GASSER, Hochst (AT)

Correspondence Address: WENDEROTH, LIND & PONACK, L.L.P., 1030 15th Street, N.W.,, Suite 400 East, Washington, DC, 20005-1503, US

(21) Appl. No.: 12/603,796

(22) Filed: Oct. 22, 2009

Related U.S. Application Data
(63) Continuation of application No. PCT/AT2008/000056, filed on Feb. 22, 2008.

(30) Foreign Application Priority Data
Apr. 23, 2007 (AT) A 629/2007

(51) Int. Cl. F16H 21/00

(52) U.S. Cl. 74/27

(57) ABSTRACT

The invention relates to a movable furniture part, particularly a furniture drawer, comprising a ejector device having an ejector lever and an electric motor for driving the ejector lever, wherein a retracting device is provided with traction means (4) that can be wound onto a roll (8), wherein the roll (8) can be driven by an electric motor (6, 7), and the ejector device and retracting device are mechanically connected to one another such that they can be mounted as a unit in or on a furniture body.

The present invention concerns a drive for a movable furniture part, in particular a furniture drawer, comprising an ejection device having an ejection lever and an electric motor for driving the ejection lever.

By virtue of such a drive it is possible to eject the movable furniture part from its closed end position in or on a furniture body or carcass, into an at least partially open position. It is however not possible to move the movable furniture part in opposite relationship to the opening direction in order for example to transfer it into the closed end position.

The object of the invention is to develop a drive of the general kind set forth, in such a way that its functionality is enhanced but the drive is not more complicated and expensive to fit.

That object is attained by a drive having the features of claim 1.

The provision of a retraction device allows the application of forces to the movable furniture part in the retraction direction. A cable line for example presents itself as a pulling means. It is however also possible to provide pulling means having a certain stiffness (such as for example metal bands).

The mechanical connection of the ejection device and the retraction device to afford a structural unit ensures that the drive with the combined functionalities is equally simple to fit as a drive in accordance with the state of the art, which has only an ejection device.

For example it can be provided for that purpose that the ejection device and the retraction device are arranged on a common mounting plate. A particularly preferred embodiment of the invention however is one in which the ejection device and the retraction device are arranged in a common housing.

It is particularly advantageous if it is provided that the housing has a stirrup arrestable by a lever for fastening the drive to a profile bar without a tool. That permits particularly simple mounting of the drive.

In principle a drive according to the invention can have respective dedicated electric motors for the ejection device and the retraction device.

In that case it is desirable if the ejection device and the retraction device have respective dedicated transmissions for the transmission of force from the respective electric motor to the ejection lever and the roller respectively so that the drive train of the ejection device and that of the retraction device remain mechanically separated from each other.

In such a case coupling of the ejection device and the retraction device can be effected electronically by a common control or regulating unit.

Alternatively it can be provided that the ejection lever of the ejection device and the roller of the retraction device are drivable by the same electric motor. This embodiment has the advantage that only a single electric motor is required per drive.

The operation of switching over the transmission of force from the electric motor to the ejection lever of the ejection device or to the roller of the retraction device respectively can be effected by a wide range of different couplings. A particularly preferred embodiment however is one in which the transmission of force from the electric motor is effected selectively to the ejection lever or the roller by way of a planetary transmission. A planetary transmission of that kind is distinguished by a particularly compact structure, which is of significance in particular when the ejection device and the retraction device are arranged in a common housing.

In this embodiment it can be provided that the planetary transmission is of a two-stage nature, wherein the one stage serves for the transmission of force from the electric motor to the ejection lever and the other stage serves for the transmission of force from the electric motor to the roller. Selection of the respective stage can be effected by way of a brake which is switchable by a control or regulating device and which for example can be in the form of a solenoid brake.

Each of the two stages of the planetary transmission can have its own hollow ring gear in which the respective planetary gears are accommodated, wherein the brake of each stage co-operates with the respective ring gear. Fixing the respective ring gear by the respective brake causes a rotational movement of the planetary gears.

In an embodiment of the invention it is provided that, in the stage associated with the ejection unit, the transmission of force is effected with the planetary gears rotating whereas in the stage associated with the roller the transmission of force occurs with the planetary gears stationary. That arrangement provides that the mutually opposite directions of rotation of the ejection lever and the roller can be implemented with the same direction of rotation of the electric motor.

By way of example three planetary gears can be provided for each stage.

The sun gear of the planetary transmission is formed in each stage by a common shaft drivable by the common electric motor.

As already stated a common control or regulating device for controlling or regulating the ejection device and the retraction device can be provided in each of the above-mentioned embodiments.

In each embodiment of the drive the ejection device can have a touch-latch functionality. That means that the ejection device is triggerable in the closed and/or partially or completely opened end position of the movable furniture part, by an application of force to the furniture part. The configuration of the ejection device, that is necessary for that purpose, was already disclosed in Austrian patent AT 413 472 (see in particular page 4, paragraphs 3 through 7; page 7, paragraphs 4 and 5; page 8, paragraph 6 and the Figures referred to therein) so that there is no need for a more detailed description at this juncture.

The retraction device can also be provided with such a touch-latch functionality so that overall this provides a drive having a touch-latch functionality. For that purpose it is necessary for the roller to be biased in the winding-on direction by a force storage means so that the pulling means is constantly held under a mechanical tension in the retraction direction. By virtue of that arrangement an application of force to the movable furniture part by a user can be transmitted to the roller by way of the pulling means and can be detected by way of suitable means (for example rotary potentiometers).

Further advantages and details of the invention will be apparent with reference to the Figures and the related specific description. In the Figures:

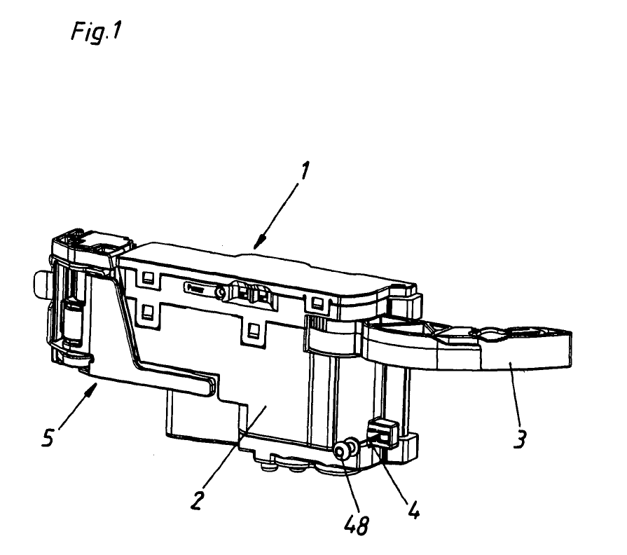

FIG. 1 shows a perspective view of an embodiment of a drive according to the invention with a common housing,

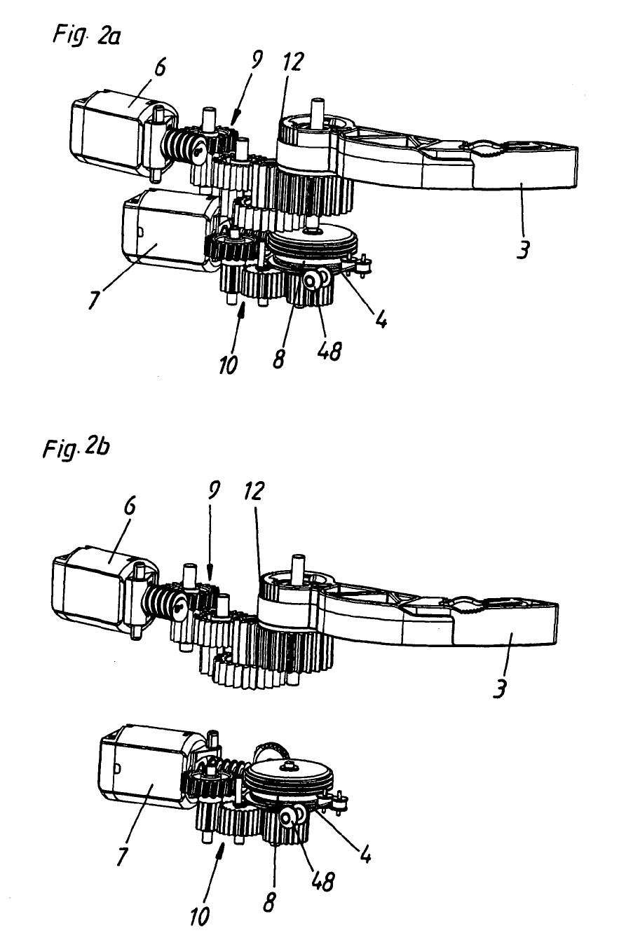

FIGS. 2a and 2b show the drive train of a first embodiment of a drive according to the invention as a perspective view and a block-wise exploded view,

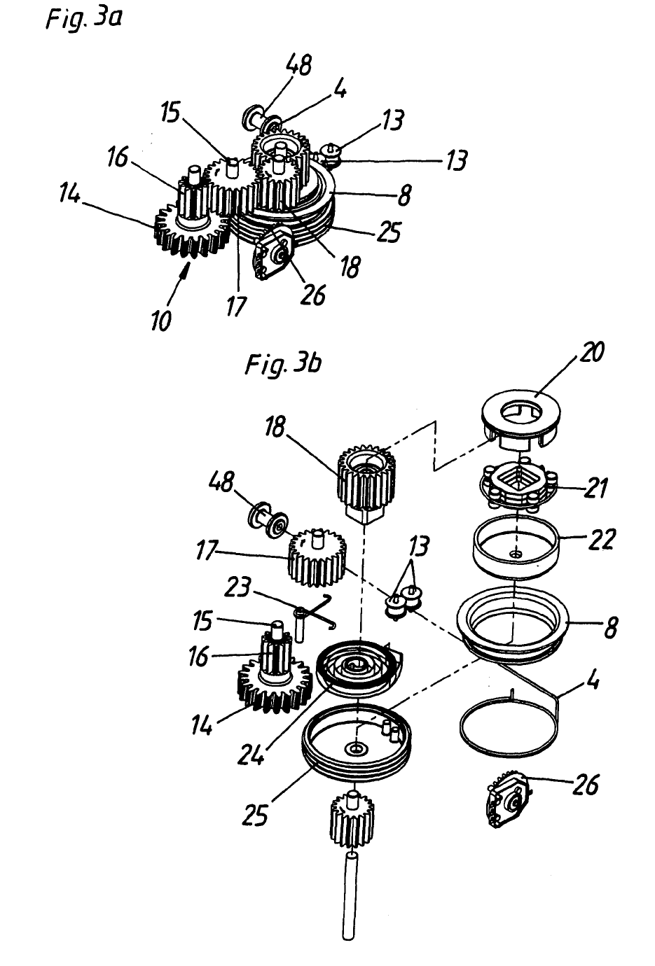

FIGS. 3a and 3b show a detail view of FIGS. 2a and 2b as a perspective view and an exploded view,

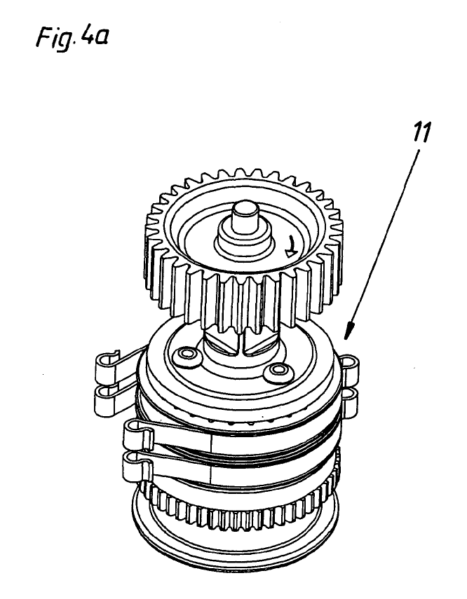

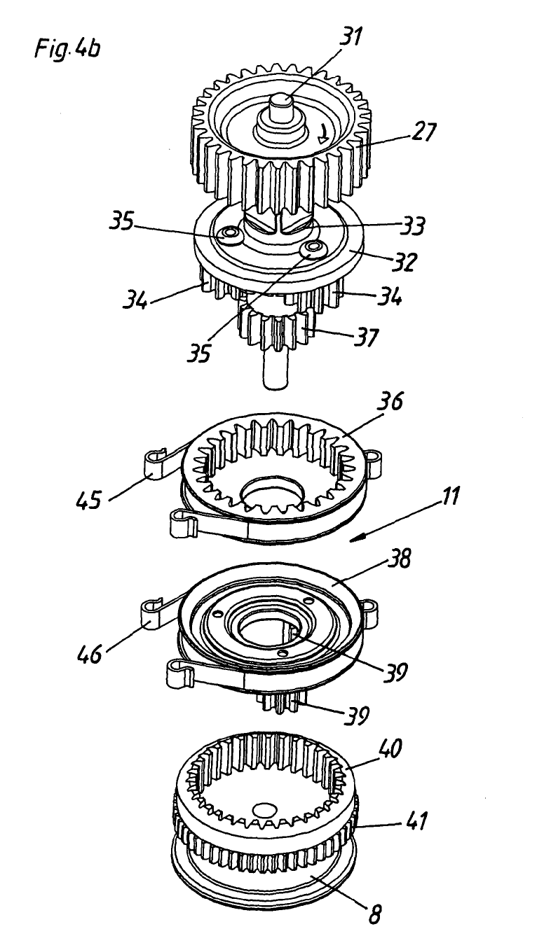

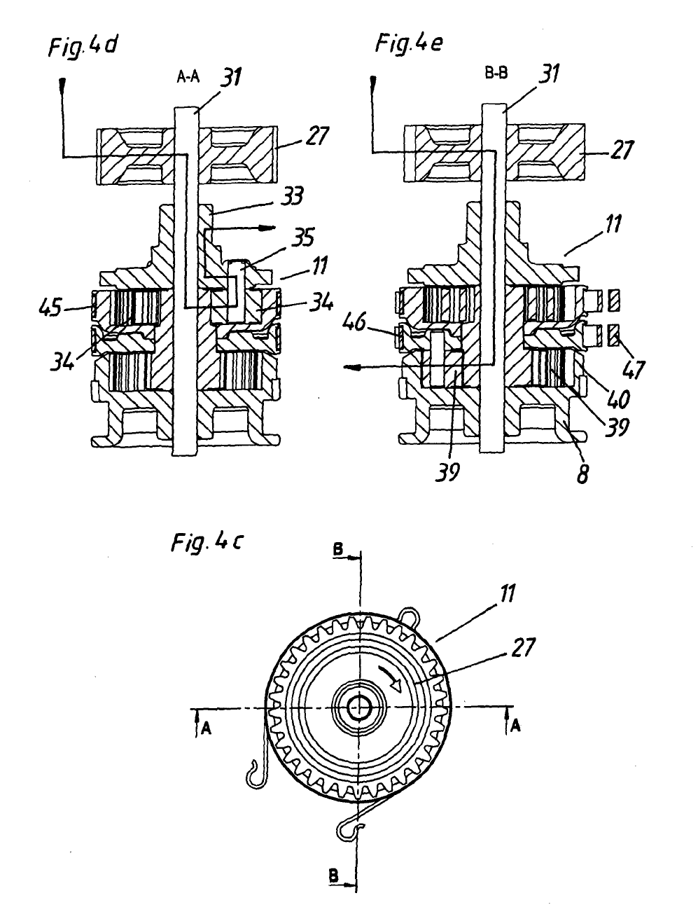

FIGS. 4 through 4e show the drive train of a second embodiment of a drive according to the invention in various perspective views and sectional views, and

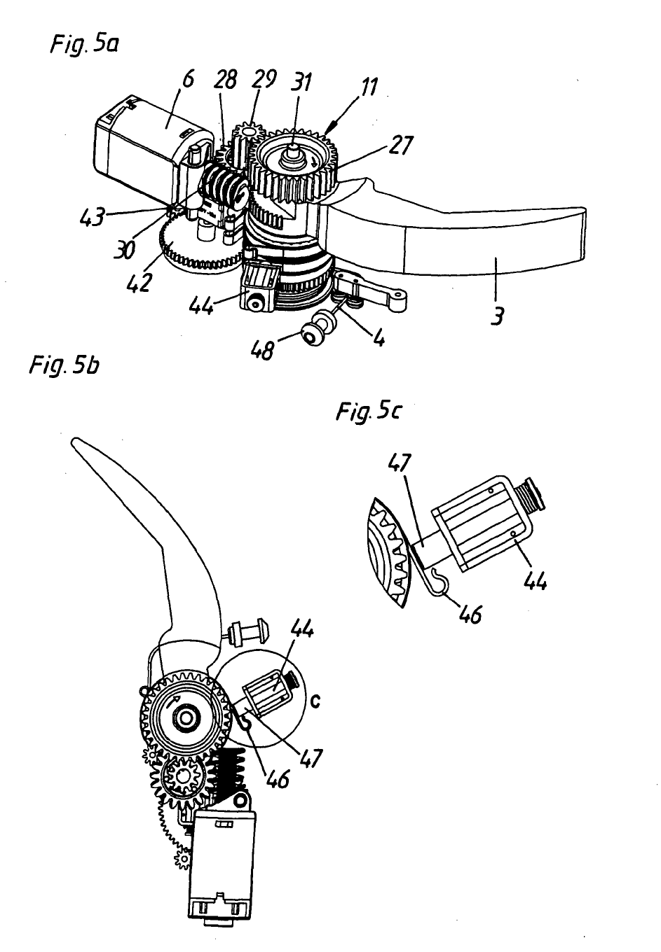

FIGS. 5a through 5c show the drive train illustrated in FIGS. 4a through 4c in further views and as a detail view.

FIG. 1 shows a perspective view of a drive 1 according to the invention in which all components are arranged in a common housing 2 or mounted therein. It is possible to see in particular the ejection lever 3 of an ejection device and the pulling means 4 of a retraction device. The drive 1 can be fastened without a tool to a profile bar (not shown) in a furniture body or carcass by way of the lever mechanism denoted by reference 5.

FIG. 2a shows a perspective view of the drive train 6, 9, 3 of the ejection device and the drive train 7, 10, 8 of the retraction device for a first embodiment of a drive 1 according to the invention, in which the ejection lever 3 of the ejection device and the roller 8 of the retraction device are drivable by separate electric motors 6 and 7 respectively and there are provided respective dedicated transmissions 9 and 10 for the transmission of force.

The drive train 6, 9, 3 of the ejection device has a transmission 9 by which the rotary speed of the electric motor 6 (for example about 6000 rpm) can be reduced by way of a series of gears. It can further be seen that the ejection lever 3 is provided in known manner (see for example FIG. 17 of AT 413 472 B) with a tooth configuration 12 with which a rotary potentiometer (not shown) meshes to ensure a touch-latch functionality.

The drive train 7, 10, 8 of the retraction device also has a transmission 10 for reducing (about 40:1) the rotary speed of the electric motor 7 (for example about 12,000 rpm) and is shown in detail in FIGS. 3a and 3b.

FIG. 2b shows that the drive trains 6, 9, 3 and 7, 10, 8 in the mounted position shown in FIG. 2a are mechanically separated from each other and are pushed as close together as possible only for reasons of space.

FIG. 3a shows the transmission 10 together with the roller 8 which is driven by the transmission 10 and on which the pulling means 4 is wound. The pulling means 4 is passed out of the housing 2 (not shown here) by way of rollers 13 and is provided at its free end with a coupling portion 48 to a corresponding coupling portion (not shown) on the movable furniture part.

The electric motor 7 drives the gear 14 by way of its worm. The gear 14 is non-rotatably connected by way of the shaft 15 to the gear 16. The gear 16 meshes with the gear 17 which in turn meshes with the gear 18. The gear 18 is non-rotatably connected to a square region 19 serving for the transmission of force to the roller 8. In this arrangement connected between the square region 19 and the roller 8 is a slipping clutch 20 through 23 which is described in detail in Austrian patent application A 1769/2006. This involves a wrap spring clutch, the outer casing 22 of which is slightly braked by the spring 23, leading to immediate shifting of the clutch.

The roller 8 is biased in the winding-on direction by a force storage means 24.

Non-rotatably connected to the roller 8 is a worm attachment 25 meshing with the drive gear 26 of a rotary potentiometer. In that case the rotary potentiometer serves to determine the position of the roller 8 to implement a touch-latch functionality and the position as a movable furniture part.

FIGS. 4a through 4e show the drive train of a second embodiment of a drive 1 according to the invention, including a common electric motor 6 for the ejection lever 3 and the roller 8 (see FIG. 5).

In this case, a planetary transmission 11 is provided for the selective transmission of force to the ejection lever 3 of the ejection device and the roller 8 of the retraction device respectively (see the perspective view in FIG. 4a). The structure of the planetary transmission 11 will be described with reference to FIG. 4b in conjunction with FIGS. 5a through 5c. The flow of force through the planetary transmission 11 is diagrammatically shown in FIGS. 4c through 4e.

The planetary transmission 11 has a first drive gear 27 drivable by way of the gears 28 and 29 by the worm 30 of an electric motor 6 (see FIG. 5a).

The drive gear 27 is arranged non-rotatably on the shaft 31 which functions as the sun gear of the planetary transmission 11. Arranged at the same shaft 31 is a gear 32 which by way of pins 35 carries three planetary gears 34 (only two planetary gears 34 can be seen in FIG. 4b). Arranged integrally with the gear 32 between the gear 32 and the gear 27 is a square region 33, on to which the ejection lever 3 of the ejection device can be fitted for drive purposes. Jointly with the ring gear 36 which is toothed at the inside the first stage of the planetary transmission 11 is formed by the components 32, 33, 34, 35 and 36 and the shaft 31 as the sun gear.

Arranged beneath the ring gear 36 is a further ring gear 38 carrying three planetary gears 39 (only two can be seen). The planetary gears 39 mesh with the internal teeth of a gear 40 which is formed integrally with the roller 8 and with the gear 37 non-rotatably connected to the shaft 31. The gear 40 further has external teeth 41 which mesh by way of a gear 42 and a gear 43 with a rotary potentiometer (not shown) (see FIG. 5a).

The second stage of the planetary transmission 11 is formed by the components 37, 38, 39 and 40 and the shaft 31 as the sun gear.

The functionality of the planetary transmission 11 will also be described in particular with reference to FIGS. 4c through 4e. In this respect, for the sake of enhanced clarity, only the respective relevant components are denoted by reference numerals in FIGS. 4d and 4e.

FIG. 4d shows the transmission of force from the electric motor 6 to the ejection lever 3 of the ejection device. The application of force is effected by way of the drive gear 27 to the shaft 31. The brake 44 associated with the first stage of the planetary transmission 11 (this cannot be seen in FIG. 5a as it is on the rear side which cannot be viewed) brakes the ring gear 36 of the first stage by way of a wrap spring 45. That causes a rotational movement of the planetary gears 34 in the ring gear 36, in meshing engagement with the inner teeth. That arrangement provides that, by way of the pins 35, the gear 32 and the square region 33 arranged thereon are rotated. That entails a drive for the ejection lever 3 of the ejection device.

In the meantime the brake 44 of the second stage remains inactive. The ring gear 38 of the second stage can freely rotate jointly with the planetary gears 39 fixed thereto, by virtue of that situation, and no force is transmitted to the gear 40 and the roller 8.

The situation is different in FIG. 4e. Here the brake 44 (see FIG. 5a) of the second stage is active and presses the wrap spring 46 against the ring gear 38. Due to the ring gear 38 being fixed the planetary gears 39 remain stationary and mesh on the one hand with the gear 37 driven by the shaft 31 and on the other hand with the internal teeth of the gear 40. By virtue thereof the drive force is transmitted from the gear 37 (sun gear) by way of the planetary gears 39 to the gear 40 and thus to the roller 8.

The first stage (transmission of force to the ejection lever 3) therefore has planetary gears 34 which rotate during the transmission of force whereby the gear 32 carrying the planetary gears 34 by way of the pins 35 is set in motion.

In contrast thereto the second stage (for the roller 8) has planetary gears 39 which are stationary during the transmission of force as in fact the ring gear 38 on which the planetary gears 39 are mounted is fixed by the wrap spring 46. That situation involves the transmission of force from the shaft 31 and the gear 37 by way of the planetary gears 39 to the gear 40. The direction of rotation however is reversed in comparison with the first stage. That is also to be required as in fact the drive direction for ejection or retraction respectively of a movable furniture part must be in mutually opposite relationship, while the direction of rotation of the shaft 31 is unchanged.

The structure of the brake 44 is also of interest, as can be seen from FIGS. 5b and 5c. It can be seen that the brake 44 has a pushrod 47 which when the brake 44 is activated presses against the associated wrap spring 45 or 46 respectively. In this embodiment the brakes 44 are in the form of solenoid brakes.

1. A drive for a movable furniture part, in particular a furniture drawer, comprising an ejection device having an ejection lever and an electric motor for driving the ejection lever, wherein there is provided a retraction device having a pulling means which can be wound on to a roller, wherein the roller is drivable by an electric motor, and the ejection device and the retraction device are mechanically connected in such a way that they can be mounted as a unit in or on a furniture body.

2. A drive as set forth in claim 1 wherein the ejection device and the retraction device are arranged in a common housing.

3. A drive as set forth in claim 2 wherein the housing has a stirrup arrestable by a lever for fastening the drive to a profile bar without a tool.

4. A drive as set forth in claim 1 wherein respective dedicated electric motors are provided for the ejection device and the retraction device.

5. A drive as set forth in claim 4 wherein the ejection device and the retraction device have respective dedicated transmissions for the transmission of force from the respective electric motor to the ejection lever and the roller respectively.

6. A drive as set forth in claim 1 wherein the ejection lever of the ejection device and the roller of the retraction device are drivable by the same electric motor.

7. A drive as set forth in claim 6 wherein the transmission of force from the electric motor is effected selectively to the ejection lever or the roller by way of a planetary transmission.

8. A drive as set forth in claim 7 wherein the planetary transmission is of a two-stage nature, wherein the one stage serves for the transmission of force from the electric motor to the ejection lever and the other stage serves for the transmission of force from the electric motor to the roller.

9. A drive as set forth in claim 8 wherein a brake is provided for each of the two stages, upon the actuation of which brake the transmission of force is effected by way of the associated stage.

10. A drive as set forth in claim 8 wherein each of the two stages has its own ring gear in which the respective planetary gears are accommodated or mounted, wherein the brake of each stage co-operates with the respective ring gear.

11. A drive as set forth in claim 10 wherein in the stage associated with the ejection unit, the transmission of force is effected with the planetary gears rotating whereas in the stage associated with the roller the transmission of force occurs with the planetary gears stationary.

12. A drive as set forth in claim 1 wherein there is provided a common control or regulating device for controlling or regulating the ejection device and the retraction device.

13. A drive as set forth in claim 1 wherein the roller is biased in the winding-on direction by a force storage means.
